(19) United States
(12) Patent Application Publication
(10) Pub. No.: US 2017/0066166 A1
(43) Pub. Date: Mar. 9, 2017

(54) APPARATUS AND METHOD FOR MANUFACTURING VEHICULAR INTERIOR PART

(71) Applicants: Kia Motors Corporation, Seoul (KR); Hyundai Motor Company, Seoul (KR)

(72) Inventors: Hee Sang Park, Seoul (KR); Dae Ik Jung, Suwon (KR); Jung Min Park, Hwaseong (KR); Dong Hyo Kim, Ansan (KR); Seon Tae Kim, Ulsan (KR)

(21) Appl. No.: 14/960,408

(22) Filed: Dec. 6, 2015

(30) Foreign Application Priority Data
Sep. 4, 2015 (KR) 10-2015-0125776

(51) Int. Cl. B29C 45/14; B29C 45/00; B29C 43/18

(52) U.S. Cl. CPC B29C 45/14786; B29C 43/18; B29C 45/0005; B29K 2313/00; B29L 2031/3005

(57) ABSTRACT

An apparatus and a method for manufacturing vehicular interior components for cutting extra fabric remaining at an exterior side of an injection-molded object prior to withdrawing a product from an interior of a mold are provided. The apparatus for manufacturing vehicular interior components includes the injection-molded object of the interior component and the fabric integrally formed in the mold by insert-injection molding. At substantially the same time, an excess fabric portion at an exterior side of the injection-molded object is cut prior to withdrawing the formed product. The removal of the extra remaining fabric at an exterior side of a product through a separate process after withdrawing the product from the interior of the mold is prevented.

### CROSS-REFERENCE TO RELATED APPLICATION

This application claims under 35 U.S.C. §119 a the benefit of Korean Patent Application No. 10-2015-0125776 filed on Sep. 4, 2015, the entire contents of which are incorporated herein by reference.

### BACKGROUND

(a) Technical Field

The present disclosure relates to an apparatus and a method for manufacturing vehicular interior components and more particularly, to components for cutting extra fabric remaining at an exterior side of an injection-molded object prior to withdrawing a product from an interior of a mold when forming the injection-molded product.

(b) Background Art

Typically, pillars for a vehicle serve as framework that is installed at lateral sides of the vehicle and connect a roof and frames. For example, pillars are classified into A pillars which support lateral sides of a front window, B pillars which serve as frames for front and rear doors, and C pillars which support lateral sides of a rear window. A pillar trim, which covers the pillar and decorates the interior space, is exposed to the interior of the vehicle, and thus the pillar trim is finished with a material identical with or similar to a finishing material used for the interior design. In other words, a fabric made of leather or woven fabric is attached to a surface of an injection-molded object of the pillar trim, thereby creating a luxurious interior. The fabric is attached to the pillar trim when the injection-molded object is formed in a mold.

Generally, when inserting a fabric into the mold and then forming a product, the tension of the fabric should be adjusted. When the tension is insufficient, there may be a wrinkled surface, and when the tension is too high, leakage of a liquid may occur. To maintain predetermined tension, a predetermined gap needs to be formed between an upper mold and a lower mold to additionally supply a fabric during injection. When extra fabric remaining at an exterior side of the injection-molded object is cut before injection, the tension of the fabric is not maintained during injection. Accordingly, leakage of a liquid may occur, which causes a problem with the molding.

The fabric may be cut by closing the upper and lower molds after the molding. However, the injection-molded object may occupy a space in the mold when the molding is completed, the upper and lower molds cannot be normally closed, and when pressure is forcedly applied to the upper and lower molds, the injection-molded object is damaged. Therefore, when the injection-molded object and the fabric are formed at the same time by insert-injection molding, an extra portion of the fabric should be removed through a separate process. Consequently, the cutting work for cutting the fabric should be performed after injection. Further, an additional space, in which the mold may be operated, is required to cut the fabric after injection and before withdrawing the product.

The above information disclosed in this section is merely for enhancement of understanding the background of the invention and therefore it may contain information that does not form the prior art that is already known in this country to a person of ordinary skill in the art.

### SUMMARY

The present invention provides an apparatus and a method for manufacturing vehicular interior components, for cutting an extra fabric remaining at an exterior side of an injection-molded object, after integrally forming the injection-molded object and the fabric by insert-injection molding and before withdrawing the product from an interior of a mold, during manufacturing a vehicular interior component like a pillar trim with a fabric formed on a surface thereof.

In one aspect of an exemplary embodiment, an apparatus for manufacturing vehicular interior components may include an upper mold and a lower mold that may form an injection-molded object that supplies resin onto one surface of a fabric inserted between the upper mold and the lower mold. The apparatus may further include a lower mold main core that forms a cavity into which the resin may be injected between the lower mold main core and the upper mold, and may be disposed on the lower mold to be retracted from the upper mold. An upper mold slide core may be disposed on the upper mold to move (e.g., forward) toward the lower mold main core when the upper mold and the lower mold are closed, a section of the fabric (e.g., a partial section of the fabric) may be pressed and supported between the lower mold main core and the upper mold slide core. Further, fabrics at an exterior side of the injection-molded object formed on a surface of the fabric pressed and supported between the upper mold and the lower mold may be cut by a compression force.

In an exemplary embodiment, the lower mold main core may include an under cutting surface portion that may be formed at and incline and disposed at a lower side of a lateral protruding portion. The protruding portion may extend outward from the lower mold main core. The upper mold slide core may include with an upper cutting surface portion that has surface-to-surface contact with the under cutting surface portion with the interposed fabric pressed and supported between the upper mold and the lower mold when the upper mold slide core translates toward the lower mold main core.

The apparatus may include a stopper that forms a gap between the upper mold and the lower mold when the upper mold and the lower mold are closed. When the stopper is disposed on the lower mold to protrude while moving forward toward the upper mold, or disposed on the upper mold to protrude while moving forward toward the lower mold. The stopper may protrude less than a thickness of the fabric inserted between the upper mold and the lower mold when the stopper extends between the upper mold and the lower mold. The apparatus may include a lower mold cam block that supports lower ends of the lower mold main core and the stopper to retract the lower ends of the lower mold main core and the stopper.

A bent lower end portion of the upper mold cam block may be penetratively inserted into an aperture formed having an incline in the upper mold slide core. The upper mold cam block may move forward toward the lower mold while penetrating the upper mold by an upper mold hydraulic cylinder installed on the upper mold A coupling groove into which the lower end portion of the upper mold cam block which penetrates the upper mold slide core is inserted may be formed in the lower mold. The lower end portion of the upper mold cam block may be inserted into the coupling groove to fixedly support the upper mold slide core. When the lower end portion of the upper mold cam block is inserted into the coupling groove of the lower mold, a gap between the upper cutting surface portion of the upper mold slide core and the under cutting surface portion of the lower mold main core may have a size less than a thickness of the fabric inserted between the upper cutting surface portion and the under cutting surface portion.

In another aspect, a method of manufacturing vehicular interior components, may include an upper mold and a lower mold and forms an injection-molded object when resin is supplied onto a surface of a fabric inserted between the upper mold and the lower mold. The method may include closing the upper mold and the lower mold when the fabric is inserted; and moving an upper mold slide core installed on the upper mold to a lower mold main core installed on the lower mold, and allowing an upper cutting surface portion formed at a front end portion of the upper mold slide core to come into surface-to-surface contact with an under cutting surface portion formed on an upper exterior circumferential surface of the lower mold main core with the fabric interposed therebetween.

The method may further include forming an injection-molded object on one surface of the fabric, retracting at least one of the upper mold and the lower mold main core, and cutting the fabric by compressing the fabric pressed and supported between the upper cutting surface portion and the under cutting surface portion among extra fabrics at an exterior side of the injection-molded object. Additionally, the method may include separating the upper cutting surface portion and the under cutting surface portion by retracting the upper mold slide core, and then cutting an extra fabric at the exterior side of the injection-molded object by compressing the fabric between the upper mold and the lower mold by closing the upper mold and the lower mold.

In some exemplary embodiments, to prevent the fabric from being damaged when the upper mold and the lower mold are closed, a fine gap may be formed between the upper mold and the lower mold by a stopper disposed on the upper mold or the lower mold to move forward and extends between the upper mold and the lower mold. For example, the gap may be formed to have a size less than a thickness of the fabric. A gap between the upper cutting surface portion and the under cutting surface portion may be formed to have a size less than a thickness of the fabric inserted between the upper cutting surface portion and the under cutting surface portion.

In another exemplary embodiment lower mold cam block, may support a lower end of the lower mold main core to retract the lower mold main, and may be moved forward. For example, the lower mold main core may be retracted, or the upper mold may be retracted, and the upper cutting surface portion of the upper mold slide core movably connected integrally with the upper mold may be pressed on the under cutting surface portion of the lower mold main core.

According to the apparatus and the method for manufacturing vehicular interior components according to the present invention, the injection-molded object of the interior component and the fabric may be integrally formed in the mold by insert-injection molding. At the same time, an extra fabric portion at an exterior side of the injection-molded object may be cut prior to withdrawing the formed product, eliminating a separate process to remove extra fabric remaining at an exterior side of a product after withdrawing the product from the interior of the mold.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is an exemplary cross-sectional configuration view for explaining an apparatus for manufacturing vehicular interior components according to an exemplary embodiment of the present invention;

FIG. 2 is an exemplary view of a pillar trim to be manufactured by the apparatus for manufacturing vehicular interior components according to the exemplary embodiment of the present invention;

FIGS. 3 to 9C are exemplary views illustrating an operation sequence of a process of manufacturing the pillar trim using the apparatus for manufacturing vehicular interior components according to the exemplary embodiment of the present invention; and

FIG. 10 is an exemplary view of a process of post-processing the pillar trim using the apparatus for manufacturing vehicular interior components according to the exemplary embodiment of the present invention.

Reference numerals set forth in the Drawings include reference to the following elements as further discussed below:
up: product (interior component)
12: fabric
14: injection-molded object
100: upper mold
104: pin
110: upper mold hydraulic cylinder
120: upper mold cam block
130: upper mold slide core
132: upper cutting surface portion
134: aperture
200: lower mold
202: coupling groove
204: pin groove
210: lower mold hydraulic cylinder
220: lower mold cam block
230: lower mold main core
232: lateral protruding portion
234: under cutting surface portion
236: gate
240: stopper

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent components of the present invention throughout the several figures of the drawing.

### DETAILED DESCRIPTION

Hereinafter, reference will now be made in detail to various exemplary embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

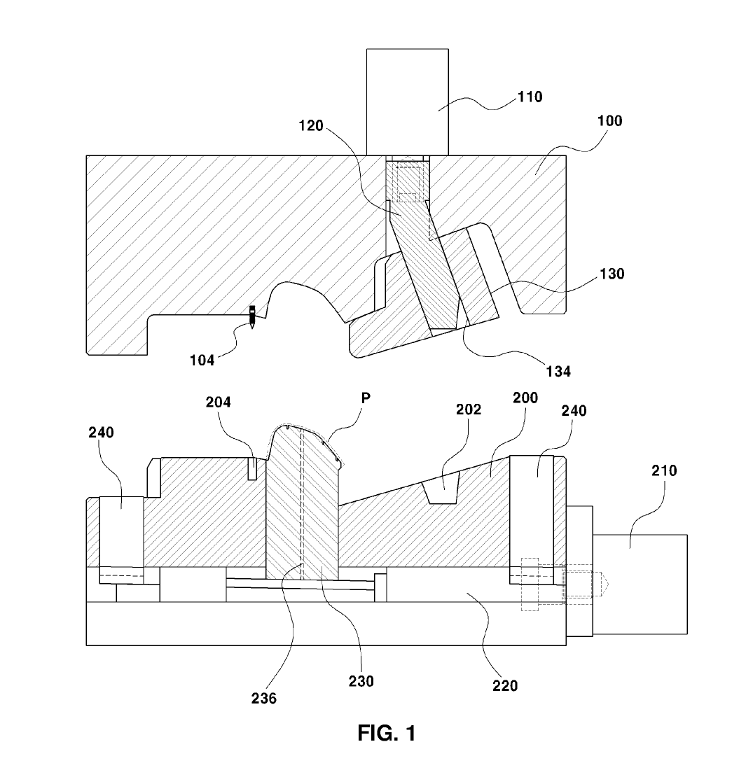

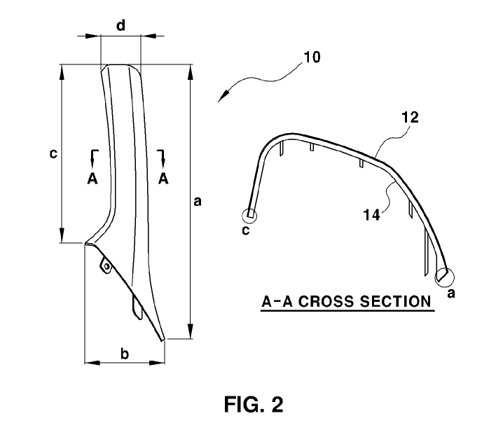

As illustrated in FIG. 1, an apparatus for manufacturing vehicular interior components according to an exemplary embodiment may include a mold device that forms an injection-molded object (see 14 in FIG. 2) by supplying resin onto a surface of a fabric (see 12 in FIG. 2) inserted between an upper mold 100 and a lower mold 200. The apparatus may include the upper mold 100, the lower mold 200 coupled to the upper mold 100 to close the mold, an upper mold slide core 130 installed on the upper mold 100 to be slidable in a diagonal direction, a lower mold main core 230 installed on the lower mold 200 to be movable upward and downward. The apparatus may further include, a stopper 240, an upper mold cam block 120 and an upper mold hydraulic cylinder 110 that may function as an actuator configured to move the upper mold slide core 130, and a lower mold cam block 220 and a lower mold hydraulic cylinder 210 that may function as an actuator configured to move the lower mold main core 230 and the stopper 240.

The lower mold main core 230 may be disposed on the lower mold 200 to be retracted from the upper mold 100, and may form a cavity P that forms the injection-molded object (14 in FIG. 2) by injecting resin between the lower mold 200 and the upper mold 100 when the mold is closed. The upper mold slide core 130 may move forward toward the lower mold main core 230 or may retract from the lower mold main core 230 when the upper mold 100 and the lower mold 200 are closed. For example, a bent lower end portion of the upper mold cam block 120 may be penetratively inserted and connected into an aperture 134 formed at an incline in the upper mold slide core 130. The upper mold cam block 120 may move forward to the lower mold 200 or may retract from the lower mold 200 while penetrating the upper mold 100 by hydraulic pressure from the upper mold hydraulic cylinder 110 installed on the upper mold 100.

The stopper 240 may form a fine gap (e.g., space) between the upper mold 100 and the lower mold 200 when the upper mold 100 and the lower mold 200 are closed. The stopper 240 may be installed and disposed on the lower mold 200 to protrude by moving forward toward the upper mold 100 as illustrated in FIG. 1. Alternatively, although not illustrated in the drawings, the stopper 240 may be installed and disposed on the upper mold 100 to protrude by moving forward toward the lower mold 200.

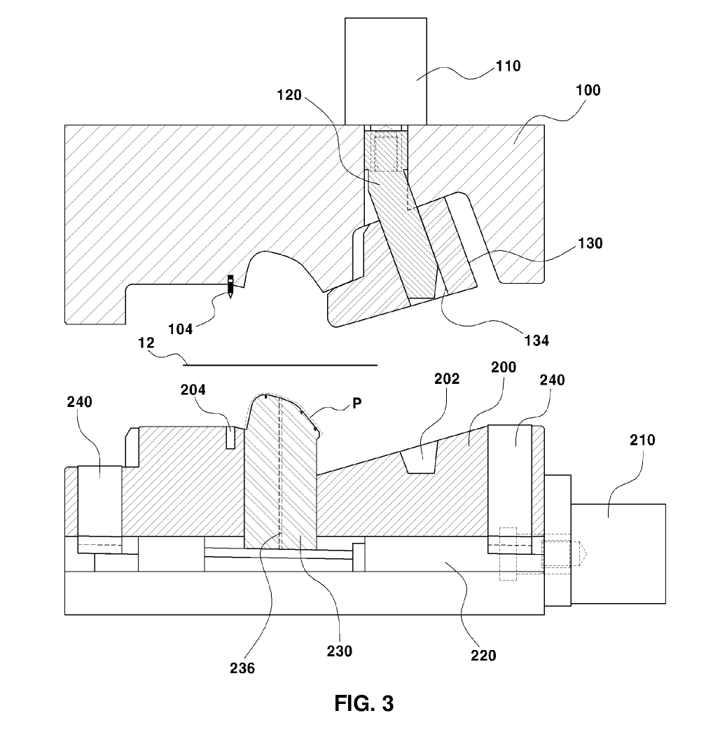

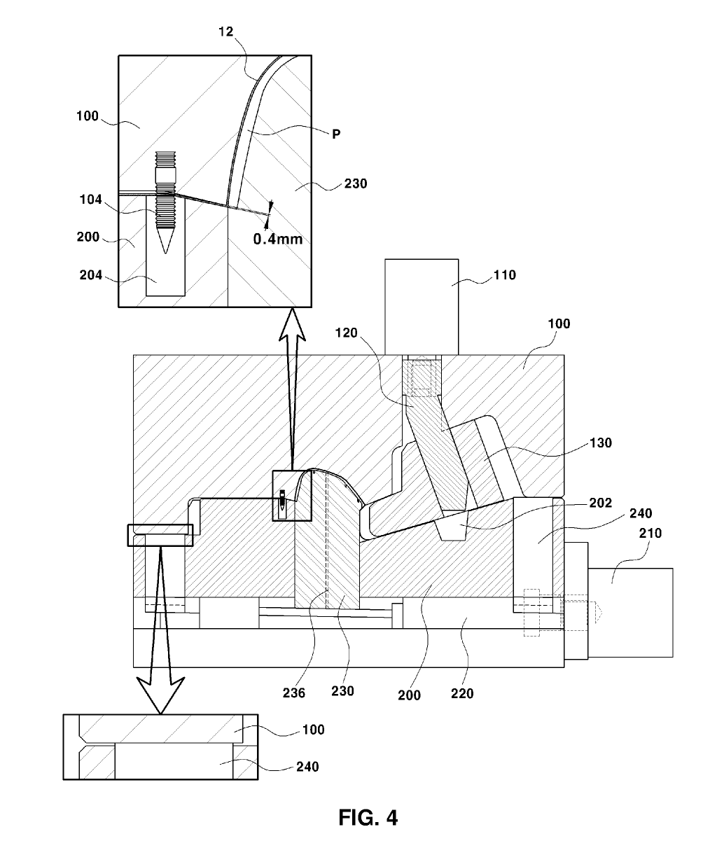

The upper mold 100 and the lower mold 200 may be closed when the stopper 240 extends between the upper mold 100 and the lower mold 200, and may prevent damage to the fabric (see 12 in FIG. 3) pressed and supported between the upper mold 100 and the lower mold 200. In other words, the stopper 240 protrudes to a thickness less than the thickness of the fabric (see 12 in FIG. 4) when the stopper 240 extends between the upper mold 100 and the lower mold 200. Accordingly damage to the fabric 12, may be prevented including tearing when the fabric 12 is pressed and supported between the upper mold 100 and the lower mold 200.

A lateral protruding portion 232, that extends outward, may be disposed on an upper exterior circumferential surface of the lower mold main core 230, and an under cutting surface portion 234, that may be formed at an incline, and disposed at a lower side of the lateral protruding portion 232. An upper cutting surface portion 132 may be disposed at a front end portion of the upper mold slide core 130, and when the upper mold slide core 130 translates toward the lower mold main core 230, the upper cutting surface portion 132 comes into surface-to-surface contact with the under cutting surface portion 234. Further, the fabric, may be pressed and supported between the upper mold 100 and the lower mold 200, and may be interposed between the upper cutting surface portion 132 and the under cutting surface portion 234. The upper cutting surface portion 132 may have an inclined shape that corresponds to the under cutting surface portion 234.

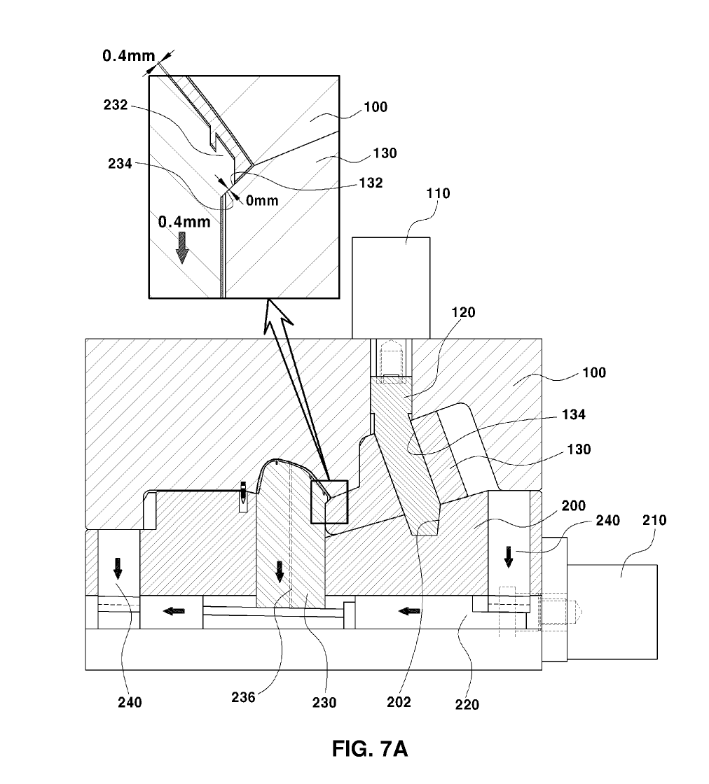

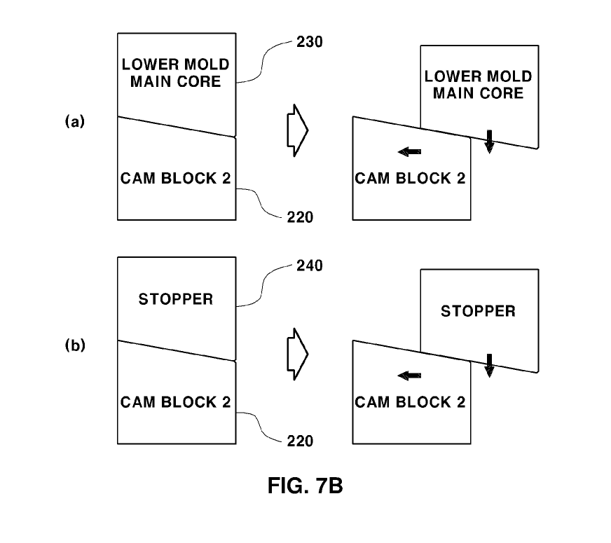

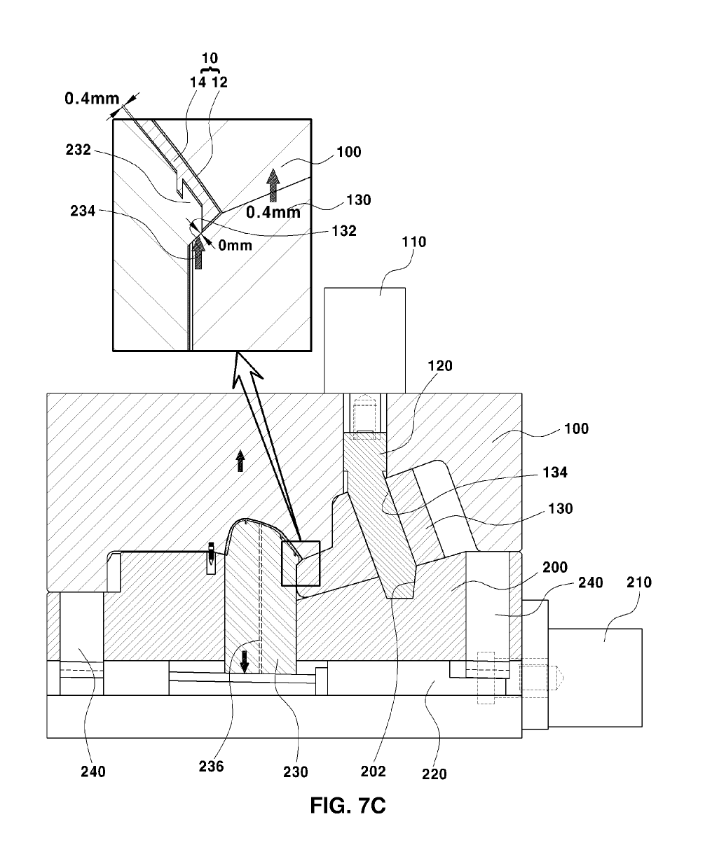

The lower mold cam block 220, may be operated by hydraulic pressure from the lower mold hydraulic cylinder 210 installed on the lower mold 200, and may support lower ends of the lower mold main core 230 and the stopper 240. To retract the lower mold main core 230 and the stopper 240. Referring to FIG. 7B, an inclined surface (e.g., a slide groove with an inclined bottom surface) structure for sliding the lower mold main core 230 and the stopper 240 may be disposed at a portion where the lower end of the lower mold main core 230 may be supported and a portion where the lower end of the stopper 240 may be supported. Therefore, when the lower mold cam block 220 translates, the lower mold main core 230 and the stopper 240 may be retracted by being slid by the inclined surface structure.

As discussed in the above configurations, a fabric section may be pressed and supported between the lower mold main core 230 and the upper mold slide core 130. The, extra fabrics at an exterior side of the injection-molded object 14 formed on a surface of the fabric 12 may be pressed and supported between the upper mold 100 and the lower mold 200. The fabric may be cut by compression between the under cutting surface portion 234 and the upper cutting surface portion 132.

For example, a process of manufacturing a pillar trim using the apparatus for manufacturing vehicular interior components according to the present invention, which is based on the above configurations, will be described with reference to the attached FIGS. 2 to 10. During the manufacturing a vehicular interior component 10 such as a pillar trim having edge portions and cross-sectional structure as illustrated in FIG. 2, the fabric 12 may be inserted between the upper mold 100 and the lower mold 200. The mold may be primarily closed, and the injection-molded object 14 may be formed by injecting resin for forming the injection-molded object of the interior component into the cavity (space to be filled with resin) P. The cavity P may be filled with the resin when the tension of the fabric 12 is maintained, and the extra fabric within section (a) may be cut through a primary fabric cutting process. Thereafter, the extra fabric within sections (b), (c), and (d) may be cut through a secondary cutting process. A process of operating the apparatus for manufacturing vehicular interior components will be sequentially described below.

As illustrated in FIG. 3, the upper mold 100 and the lower mold 200 may be opened when the upper mold slide core 130 moves upward and retracts. The fabric 12 may be inserted after the upper mold 100 and the lower mold 200 are opened. Referring to FIG. 4, when the upper mold 100 and the lower mold 200 are primarily closed the fabric 12 may be inserted. The fabric 12 may be interposed and fixed between the upper mold 100 and the lower mold 200. For example, a space may be formed based on of a thickness of the fabric. Namely, a gap of about 0.4 mm may be present between the upper mold 100 and the lower mold 200 by the stopper 240 that protrudes upward from an upper end surface of the lower mold 200, and may prevent damage to the fabric 12.

The stopper 240 may be installed and coupled to the lower mold 200 to move upward and downward, and the lower end of the stopper 240 may be supported by the lower mold cam block 220. The stopper 240 may be maintained when the stopper 240 extends upward by a predetermined height, for example, a height of about 0.4 mm from the upper end surface of the lower mold 200. For example, the predetermined height may be set to a height value for fixedly holding the fabric by pressing and supporting the fabric between the upper mold 100 and the lower mold 200 and may prevent the fabric from being torn. The fabric 12 may be fixed by being interposed between the upper mold 100 and the lower mold 200 at a position that corresponds to the exterior side of the product 10. Further, the fabric may be fixed once more by a pin 104, installed at a lower surface portion of the upper mold 100 to protrude, at a position that corresponds to sections (c) and (d) of the product 10 (see FIG. 2).

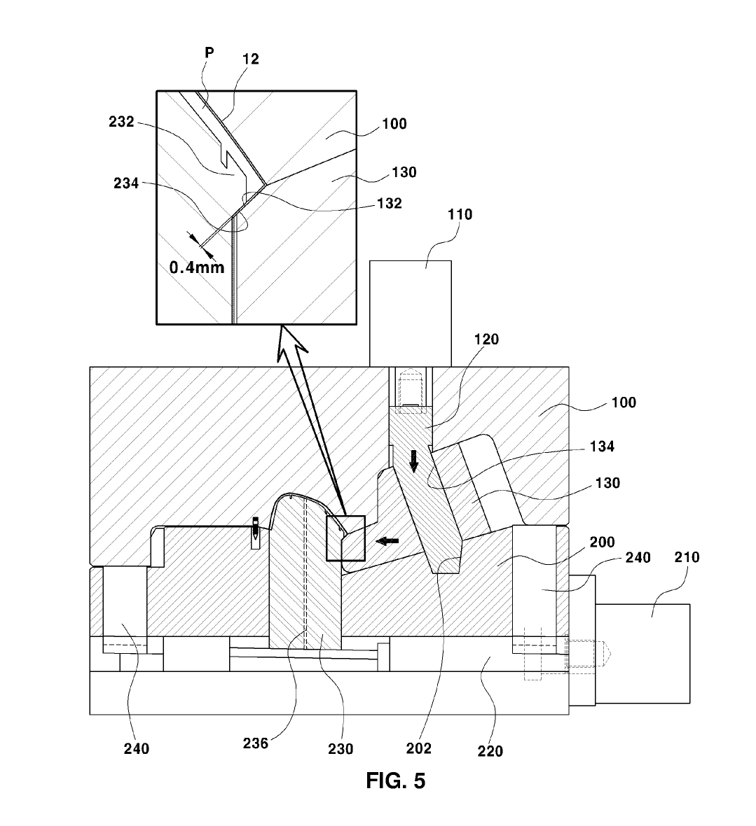

As illustrated in FIG. 5, when the upper mold 100 and the lower mold 200 are primarily closed, the upper mold cam block 120 may translate forward and downward by the operation of hydraulic pressure from the upper mold hydraulic cylinder 110. Simultaneously, the upper mold slide core 130 may move forward and downward in the diagonal direction, and a space. For example, a gap of about 0.4 mm may be formed based on a thickness of the fabric, between the lower mold main core 230 and the upper mold slide core 130, thereby preventing damage to the fabric.

In particular, the upper mold slide core 130 translates up to a position that may be set based on a movement distance of the upper mold cam block 120 and a designed structure of a core operating space portion (e.g., a space disposed in the upper mold for operating the upper mold slide core). The under cutting surface portion 234 of the lower mold main core 230 may contact the upper cutting surface portion 132 of the upper mold slide core 130 while positioned adjacent to the upper cutting surface portion 132 of the upper mold slide core 130 with the fabric 12 interposed therebetween. The under cutting surface portion 234 and the upper cutting surface portion 132 may provide a space (e.g., fine gap) that may prevent the fabric 12 from being torn, for instance the gap may press and support the fabric 12 interposed between the under cutting surface portion 234 and the upper cutting surface portion 132. Therefore, a portion of the fabric 12 that corresponds to the position of a rim of the injection-molded object 14 of the product 10 may be fixed by being pressed and supported.

The under cutting surface portion 234 may be formed on the lateral protruding portion 232 of the lower mold main core 230. The upper cutting surface portion 132 may be formed at the upper side of the front end portion of the upper mold slide core 130 and may be formed to have inclined surface structures that correspond to each other. When the lower end portion of the upper mold cam block 120 is inserted into a coupling groove 202 of the lower mold 200, the upper cutting surface portion 132 may move to press and support the fabric (e.g., fabric, within certain sections, of the extra fabric at the exterior side of the injection-molded object), thereby holding the fabric.

The forward and rearward movement of the upper mold slide core 130 may be accomplished by the upward and downward movement of the upper mold cam block 120. The movement may be implemented by a structure in which the aperture 134 disposed within the upper mold slide core 130 may be formed having an incline. Further, the upper mold cam block 120, of which one side (e.g., the bent lower end portion) may be inserted into the aperture 134, and may move vertically upward and downward in the upper mold 100.

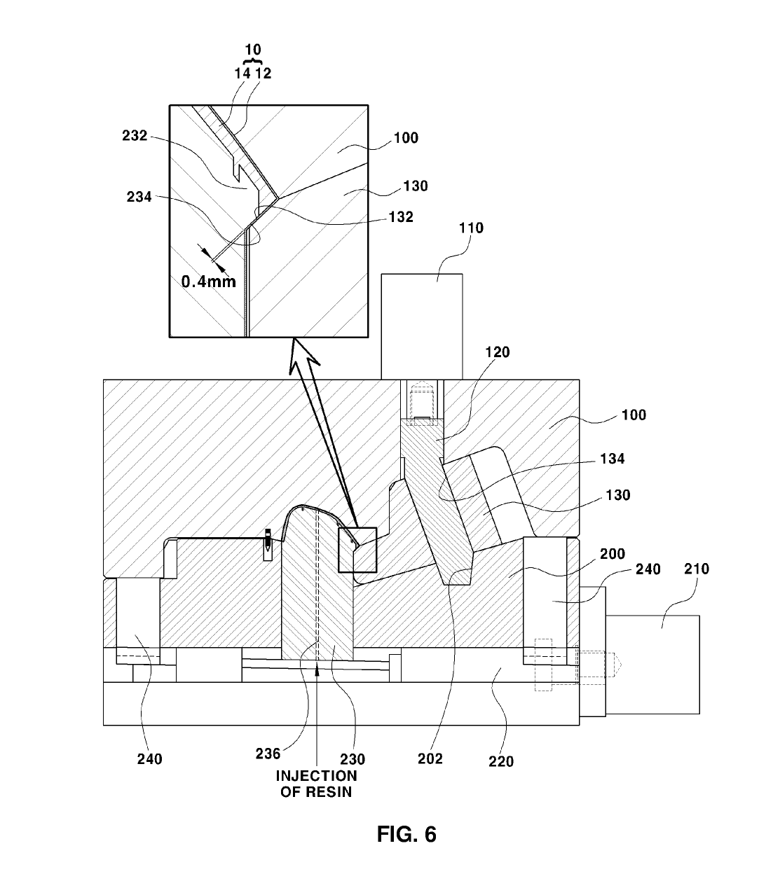

Referring to FIG. 6 when the fabric 12 is fixed at the position of the rim of the injection-molded object of the product (e.g., interior component) and the tension of the fabric 12 is maintained, the resin may be injected into the cavity P between the upper mold 100 and the lower mold main core 230 to form the injection-molded object 14 of the interior component 10 may be formed. For example, the resin may be injected from the lower end of the lower mold main core 230 through a gate 236 to fill the cavity P with the resin simultaneously when the cavity P is filled with the resin, the fabric 12 may be attached to the surface of the injection-molded object 14 while the injection-molded object 14 is formed.

As illustrated in FIG. 7A, the lower mold main core 230 moves downward and the fabric may be primarily cut by the sliding attachment at joint surfaces between the under cutting surface portion 234 and the upper cutting surface portion 132. When the lower mold main core 230 retracts, the fabric may be cut by force produced at the joint surfaces between the under cutting surface portion 234 and the upper cutting surface portion 132 and by the sliding attachment with the upper mold slide core 130.

In other words, as the lower mold main core 230 retracts, the upper mold slide core 130 with a fixed position and the lower end portion of the upper mold cam block 120 may be coupled thereto. For example, the upper mold block 120 may be inserted into the coupling groove 202 in the lower mold 200, and may be fixed by attachment to the lower mold main core 230 at the joint surfaces while being in contact with the lower mold main core 230. A partial section (portion (a) in FIG. 2) of the fabric 12 may be primarily cut by compression. Further, the lower mold cam block 220, may be installed to operate in conjunction with the lower mold hydraulic cylinder 210, to move forward when a piston of the lower mold hydraulic cylinder 210 advances forward. The lower mold main core 230 and the stopper 240 may retract by a predetermined distance, for example, of about 0.4 mm.

Referring to FIG. 7B, an inclined surface structure that may be inclined at a predetermined angle (e.g., a slide groove with an inclined bottom surface) may be processed at the portions of the lower mold cam block 220 where the lower end surfaces of the lower mold main core 230 and the stopper 240 are supported. The lower end surfaces of the lower mold main core 230 and the stopper 240 may be processed to have inclined surfaces having inclined angles that correspond to the inclined surface structure of the lower mold cam block 220. Therefore, when the lower mold cam block 220 advances forward by the lower mold hydraulic cylinder 210, the lower mold main core 230 moves downward by a predetermined distance of about 0.4 mm. A predetermined space of about 0.4 mm may be formed between the lower mold main core 230 and the product 10.

To primarily cut the partial section (portion (a) in FIG. 2) of the fabric 12 as described above, the upper mold 100 may be retracted and moved upward by controlling the mold. For example, the upper mold slide core 130 connected to the upper mold 100 may also be retracted, as illustrated in FIG. 7C. Additionally, the partial section (portion (a) in FIG. 2) of the fabric 12 may be cut by the sliding attachment with the lower mold main core 230 at the joint surfaces between the under cutting surface portion 234 and the upper cutting surface portion 132 while the upper mold slide core 130 may be retracted. In particular, by a relative movement of the upper mold 100 and the lower mold 200, a predetermined space (gap) of about 0.4 mm may be formed between the lower mold 100 and the injection-molded object 14 of the product 10.

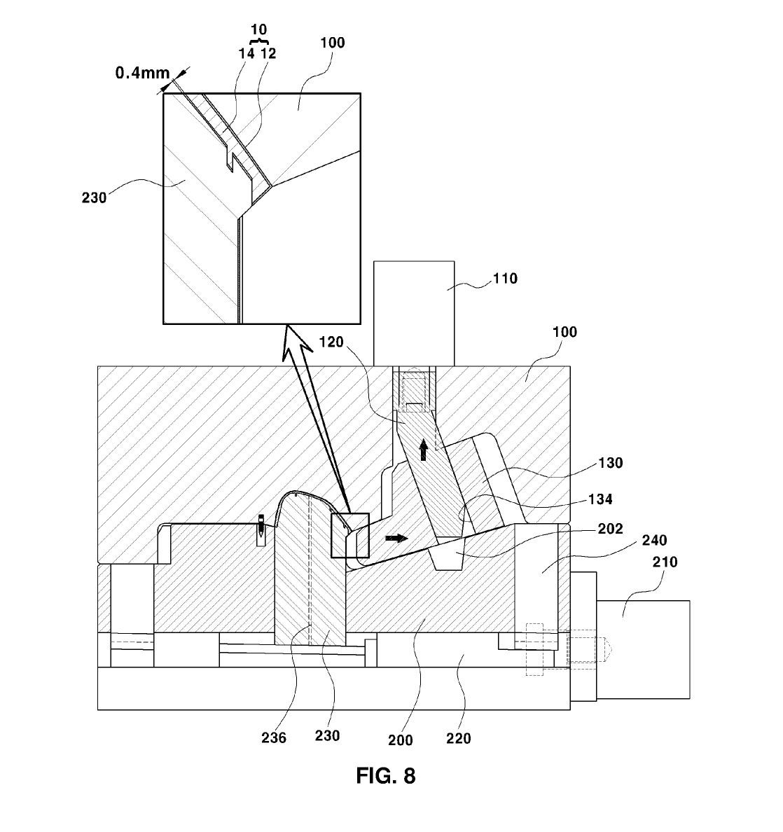

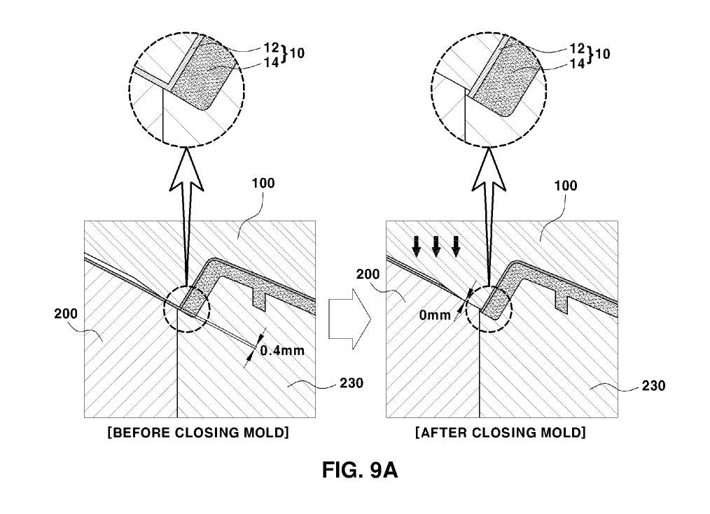

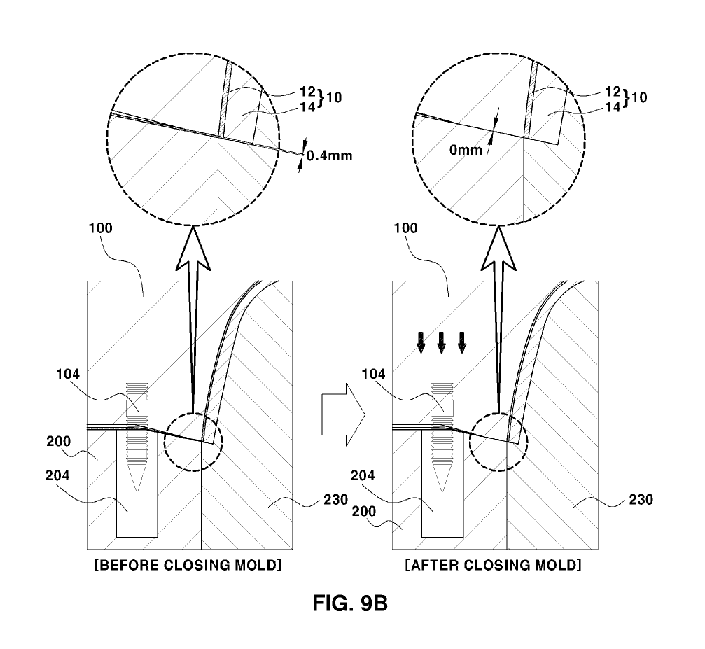

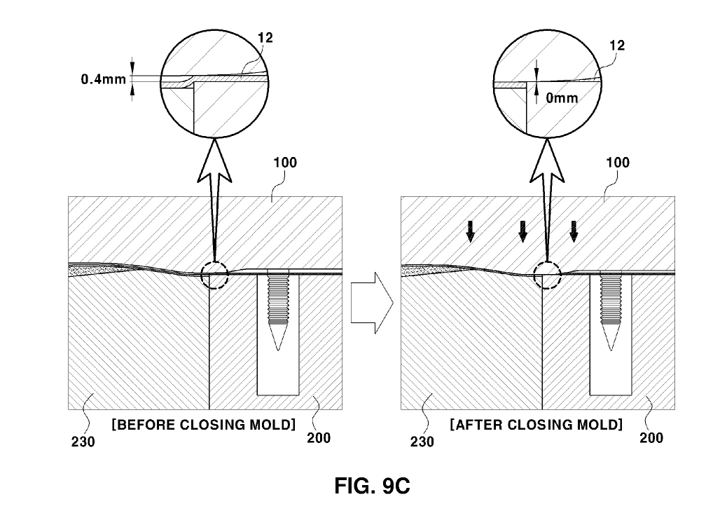

After the partial section (portion (a) in FIG. 2) of the fabric 12 may be primarily cut as illustrated in FIG. 7A, the piston of the upper mold hydraulic cylinder 110 may be operated to be retracted as illustrated in FIG. 8. Additionally, the upper mold cam block 120 and the upper mold slide core 130, movably connected integrally with the upper mold hydraulic cylinder 110, may be retracted simultaneously. The space, formed as a predetermined gap of about 0.4 mm between the upper mold 100 and the lower mold 200 by the operations of the molds for cutting the partial section (portion (a) in FIG. 2) of the fabric 12 in the primary cutting step, may be eliminated by secondarily closing the mold. A space (gap) between the upper mold 100 and the lower mold 200 may become about 0 mm. Therefore, the remaining section of the fabric, that has not been cut in the primary cutting step, (e.g., sections (b), (c), and (d) in FIG. 2) may be secondarily cut by compression by the upper mold 100 and the lower mold 200. Secondarily cutting sections (b), (c), and (d) may be performed as illustrated in FIGS. 9A, 9B and 9C.

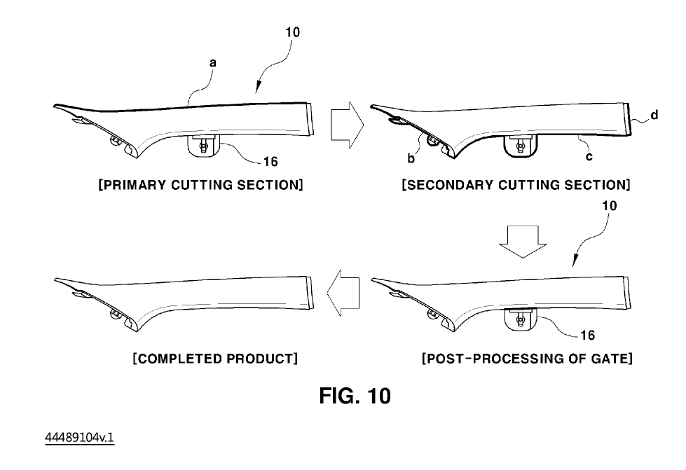

Referring to FIGS. 9A to 9C, sections (b), (c), and (d) of the fabric 12 may be pressed and supported between the upper mold 100 and the lower mold 200, respectively. Prior to the secondary closure of the molds, and when the upper mold 100 moves forward and downward, the mold may then be secondarily closed. Further at same time, a space between the upper mold 100 and the lower mold 200 becomes about 0 mm, and the fabric may be secondarily cut by compressing force by the mold. After the extra fabrics (sections (a), (b), (c), and (d) in FIG. 2) at the exterior side of the injection-molded object 14 are cut through the primary and secondary cutting steps as described above, the product 10 may be withdrawn from the opened mold, and then cut after post-processing a gate portion 16 as illustrated in FIG. 10.

When the resin is injected into the cavity P between the upper mold 100 and the lower mold main core 230, the resin with which the gate 236, a resin injection port of the lower mold main core 230 is filled, forms the gate portion 16. The gate portion 16 may be integrally connected with the injection-molded object 14 of the product 10. Accordingly, the gate portion 16, that protrudes from a rear surface of the injection-molded object 14, may be cut and removed through post-processing after the secondary cutting step, thereby completely producing a product (e.g., an injection-molded product with the fabric formed on the surface thereof).

The invention has been described in detail with reference to preferred exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. An apparatus for manufacturing vehicular interior components, comprising:
an upper mold and a lower mold that form an injection-molded object by supplying resin onto a surface of a fabric inserted between the upper mold and the lower mold;
a lower mold main core that forms a cavity into which the resin is injected between the lower mold main core and the upper mold, and is disposed on the lower mold to be retracted from the upper mold; and
an upper mold slide core disposed on the upper mold to move toward the lower mold main core when the upper mold and the lower mold are closed,
wherein a section of the fabric pressed and supported between the lower mold main core and the upper mold slide core, among extra fabrics at an exterior side of the injection-molded object formed on a surface of the fabric pressed and supported between the upper mold and the lower mold, is cut by compression.

2. The apparatus of claim 1, wherein
the lower mold main core includes an under cutting surface portion that is formed at an incline of a lower side of a lateral protruding portion that extends outward from the lower mold main core, and
the upper mold slide includes an upper cutting surface portion in surface-to-surface contact with the under cutting surface portion with the interposed fabric pressed and supported between the upper mold and the lower mold when the upper mold slide core moves toward the lower mold main core.

3. The apparatus of claim 1, further comprising:
a stopper that forms a gap between the upper mold and the lower mold when the upper mold and the lower mold are closed,
wherein the stopper is disposed on the lower mold to protrude while moving forward toward the upper mold, or disposed on the upper mold to protrude while moving forward toward the lower mold.

4. The apparatus of claim 3, wherein the stopper protrusion is less than a thickness of the fabric inserted between the upper mold and the lower mold when the stopper extends between the upper mold and the lower mold.

5. The apparatus of claim 1, further comprising:
a lower mold cam block that supports a lower end of the lower mold main core to retract the lower end of the lower mold main core.

6. The apparatus of claim 3, further comprising:
a lower mold cam block that supports a lower end of the stopper to retract the lower end of the stopper.

7. The apparatus of claim 1, wherein a bent lower end portion of the upper mold cam block is inserted into an aperture formed having an incline in the upper mold slide core, and the upper mold cam block moves toward the lower mold while penetrating the upper mold by an upper mold hydraulic cylinder installed in the upper mold.

8. The apparatus of claim 7, wherein a coupling groove is inserted into the lower end portion of the upper mold cam block, that penetrates the upper mold slide core, is formed in the lower mold, and the lower end portion of the upper mold cam block is inserted into the coupling groove to fixedly support the upper mold slide core.

9. The apparatus of claim 8, wherein when the lower end portion of the upper mold cam block is inserted into the coupling groove of the lower mold, a gap between the upper cutting surface portion of the upper mold slide core and the under cutting surface portion of the lower mold main core has a size less than a thickness of the fabric inserted between the upper cutting surface portion and the under cutting surface portion.

10. A method of manufacturing vehicular interior components, having with an upper mold and a lower mold and forms an injection-molded object by supplying resin onto one surface of a fabric inserted between the upper mold and the lower mold, the method comprising:
closing the upper mold and the lower mold when the fabric is inserted;
moving an upper mold slide core installed on the upper mold forward toward a lower mold main core installed on the lower mold, and
moving an upper cutting surface portion formed at a front end portion of the upper mold slide core to come into surface-to-surface contact with an under cutting surface portion formed on an upper exterior circumferential surface of the lower mold main core with the fabric interposed therebetween; and
forming an injection-molded object on a surface of the fabric, retracting at least one of the upper mold and the lower mold main core, and
cutting the fabric by compressing the fabric between the upper cutting surface portion and the under cutting surface portion among extra fabrics at an exterior side of the injection-molded object.

11. The method of claim 10, further comprising:
separating the upper cutting surface portion and the under cutting surface portion by retracting the upper mold slide core; and
cutting an extra fabric at the exterior side of the injection-molded object by compressing the fabric between the upper mold and the lower mold by closing the upper mold and the lower mold.

12. The method of claim 10, wherein a fine gap is formed between the upper mold and the lower mold to prevent the fabric from being damaged when the upper mold and the lower mold are closed.

13. The method of claim 10, wherein to prevent the fabric from being damaged when the upper mold and the lower mold are closed, a fine gap is formed between the upper mold and the lower mold by a stopper disposed on the upper mold or the lower mold to move forward and extends between the upper mold and the lower mold.

14. The method of claim 12, wherein when the upper mold and the lower mold are closed, a gap between the upper mold and the lower mold is formed to have a size less than a thickness of the fabric.

15. The method of claim 10, wherein a gap between the upper cutting surface portion and the under cutting surface portion is formed to have a size less than a thickness of the fabric inserted between the upper cutting surface portion and the under cutting surface portion.

16. The method of claim 10, wherein a lower mold cam block, that supports lower ends of the lower mold main core and the stopper to retract the lower mold main core and the stopper, is moved forward, and the lower mold main core and the stopper are retracted.

17. The method of claim 10, wherein the upper mold is retracted to movably integrally connect with the upper cutting surface portion of the upper mold slide core and is pressed the under cutting surface portion of the lower mold main core.
